(19) United States
(12) Patent Application Publication
(10) Pub. No.: US 2008/0043357 A1
(43) Pub. Date: Feb. 21, 2008

(54) Gain control device, storage device and, gain control method

(75) Inventors: Yoshifumi Obara, Higashine (JP); Takeshi Hara, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/646,996

(22) Filed: Dec. 28, 2006

(30) Foreign Application Priority Data
Aug. 17, 2006 (JP) 2006-222706

(51) Int. Cl. G11B 5/09

(52) U.S. Cl. 360/46

(57) ABSTRACT

Before a system area of the storage device is read immediately after the activation of the storage device, a read signal is output from a magnetic head to read servo information in the system area. An HDIC amplifies gain of the read signal as first gain amplification. Then, a VGA in a read channel amplifies gain of the read signal after the first gain amplification as second gain amplification. The read signal for the servo information is amplified by two stages of amplifiers to a level sufficient to demodulate the servo information.

### BACKGROUND OF THE INVENTION

1. Field of the Invention

The present invention relates to a technology for controlling gain of a read signal output from a head of a storage device upon activation of the storage device.

2. Description of the Related Art

When a storage device such as a magnetic disk device reads information recorded on a recording medium such as a magnetic disk therein through a magnetic head, gain of a read signal amplified by a preamplifier is controlled in a read channel to demodulate the read signal with an appropriate gain.

With regard to gain control of the read signal, for example, Japanese Patent Application Laid-open No. S57-127904 discloses a readout circuit for a magnetic disk device that can properly control the gain of the read signal different in the inner periphery and outer periphery for the magnetic disk, thereby demodulating the read signal with an appropriate gain to provide data.

Japanese Patent Application Laid-open No. S62-129973 discloses a data reproduction circuit of a magnetic recording/reproduction device that can variably set the amount of gain control performed in a gain control circuit according to the gain of a read signal from a magnetic head, thereby demodulating the read signal with an appropriate gain to provide data.

Japanese Patent Application Laid-open No. 2004-22119 discloses a magnetic head characteristic variation monitoring device that can determine output of a read signal from a magnetic head based on the gain controlled at the gain control circuit and detect output reduction of the read signal.

In the conventional technologies described in the Japanese Patent Application Laid-open Nos. S57-127904 and S62-129973, however, when read signal output from a magnetic disk is small, no matter how the signal is amplified, gain control may be insufficiently performed in a read channel, possibly leading to a demodulation error or a seek error of a magnetic disk.

In particular, after a system area of a storage medium is read, no matter how small output of a read signal from the magnetic head is, it is possible to gain control the signal. However, immediately after startup of a device before reading out a system area, due to a small output of a read signal from the magnetic head, even when the signal is gain controlled, the signal does not reach a sufficient gain. Therefore, information of a servo mark required for the seek operation of the magnetic head can not be demodulated and detected. The magnetic head can not be even on track. Alternatively, even if the servo mark can be detected, a demodulation error of a gray cord for specifying a track may occur.

A combination of the above conventional technologies enables detection of a small read signal output from a magnetic head. However, immediately after startup of a device before reading out a system area, output of a read signal from the magnetic head still can not be amplified to a sufficient level. It is impossible to overcome problems of a servo-mark detection error and a demodulation error of a gray cord.

An output range that a preamplifier can amplify is larger, an output range of the corresponding magnetic head is larger, and an output difference of the magnetic head is increasingly allowed. However, these problems decrease yield of the magnetic head because amplification can not be made to a sufficient level based on gain control, as a result, the magnetic head having small output can not be used in a storage device. Recently, though a vertical magnetic recording system becomes prevalent along with high density of a recording medium, the magnetic head that employs the vertical magnetic recording system has a large variation of output and gain control presents a significant challenge to the system.

### SUMMARY OF THE INVENTION

It is an object of the present invention to at least partially solve the problems in the conventional technology.

According to an aspect of the present invention, a gain control device that controls gain of a data read signal output from a head of a storage device upon activation of the storage device, includes a first gain control unit that controls gain of a first read signal to obtain a second read signal, and a second gain control unit that controls gain of the second read signal to obtain a third read signal.

According to another aspect of the present invention, a storage device that controls gain of a data read signal output from a head thereof upon activation, includes a first gain control unit that controls gain of a first read signal to obtain a second read signal, and a second gain control unit that controls gain of the second read signal to obtain a third read signal.

According to still another aspect of the present invention, a gain control method for controlling gain of a data read signal output from a head of a storage device upon activation of the storage device, includes controlling gain of a first read signal to obtain a second read signal, and controlling gain of the second read signal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining specific features of an embodiment of the present invention;

FIG. 2 is a schematic external view of a magnetic disk device according to the embodiment;

FIG. 3 is a schematic of an internal configuration of the magnetic disk device;

FIG. 4 is a schematic for explaining servo information;

FIG. 5 is a functional block diagram of the magnetic disk device;

FIG. 6 is a table for explaining the amplification process of gain in a VGA and an HDIC shown in FIG. 5;

FIG. 7 is a flowchart of a gain control process while a system area is being read; and

FIG. 8 is a schematic for explaining an outline of gain control.

### DETAILED DESCRIPTION OF THE PREFERRED EMBODIMENTS

Exemplary embodiments of the present invention are described in detail below with reference to the accompanying drawings. In the following embodiments, the present invention is applied, but is not limited, to a magnetic disk as a storage medium and to a magnetic disk device as a storage device. The present invention can also be applied to a storage medium and another disk device, such as an optical disc or a magneto-optical disc and an optical disc device or a magneto-optical disc device.

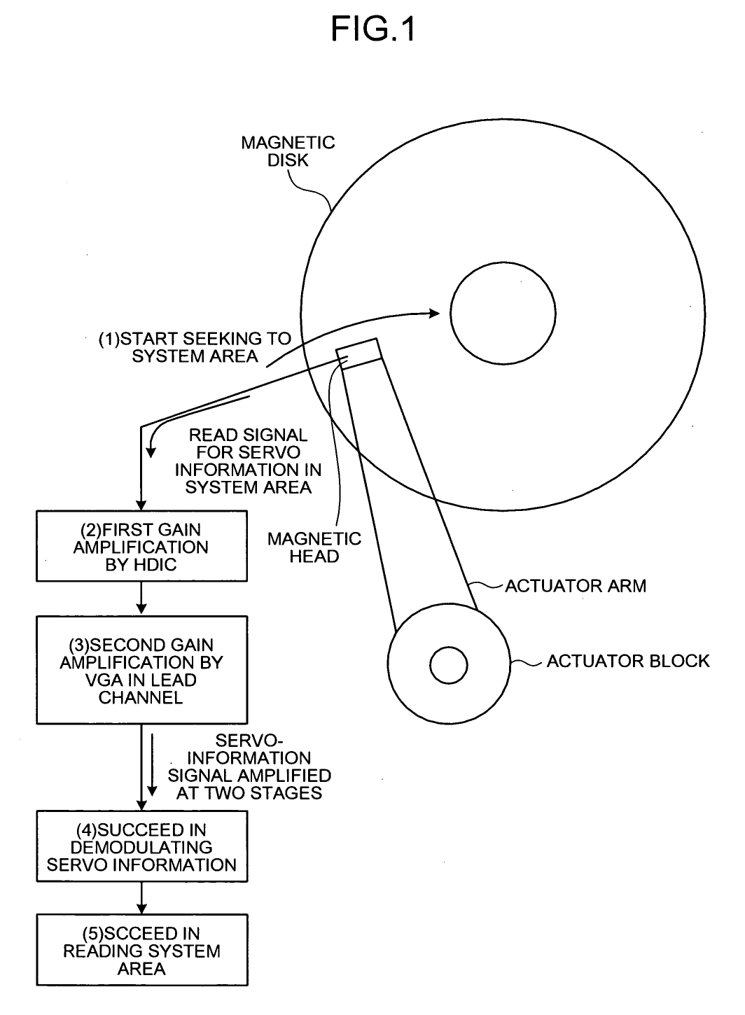

FIG. 1 is a schematic for explaining specific features of an embodiment of the present invention. As shown in FIG. 1, a magnetic head mounted on top of an actuator arm a half turn movement of which is controlled by an actuator block reads out data (servo data and user data) from the magnetic disk. Various steps according to the embodiment are included in the processing of reading out data from the magnetic disk. Note that the assumption is made that information of a system area that is recorded at a predetermined area of the magnetic disk has not been read on startup of the device (at power-on).

A device of a load/unload system first loads a magnetic head from a ramp onto the magnetic disk immediately after startup, and perform a seek to a system area (FIG. 1 (1)). In the case of a device of a contact start stop (CSS) system, the magnetic head is moved from the CSS area to perform a seek to a system area. A signal that reads out servo information of a system area is next output from the magnetic head. The first gain amplification is performed in a host interface and disk controller (HDIC) as a preamplifier with respect to the read signal for the read servo information (FIG. 1 (2)). Then, a second gain amplification is performed in a variable gain amplifier (VGA) in a read channel with respect to the read signal for the servo information to which the first gain amplification is performed (FIG. 1 (3)). Thus, the read signal for the servo information that is amplified at two stages is amplified enough to succeed in being demodulated so that demodulating of the servo information ends up succeeding (FIG. 1 (4)). This leads to success of reading out the system area (FIG. 1 (5)), and thereafter possibly optimizing the read signal from the magnetic head in response to information in the system area and demodulating the read information.

As mentioned above, an increased range of the gain in HDIC and an increased range covered by output of the magnetic head easily cause an error, when starting reading out with a gain kept fixed and demodulating a signal in the read channel, in different magnetic heads having a large difference in output, and there is a possibility that the magnetic disk is not on track. In addition, when the gain in HDIC is not suitable, an output value of the read channel (hereinafter, variable gain amplifier servo (VGAS) value) can be fixed to the value not reaching a required value. The output value can not follow a change of output in the magnetic head, there is a possibility that a demodulation error or a seek error occurs. The value of the gain in HDIC, after reading out system area information, which is controlled in response to the system area information can be used, however, the gain in HDIC is not controlled and is in an unstable manner before reading out the system area information. As a result, a system area cannot be found or a demodulation error in a gray code occurs. The present invention is provided to address these problems.

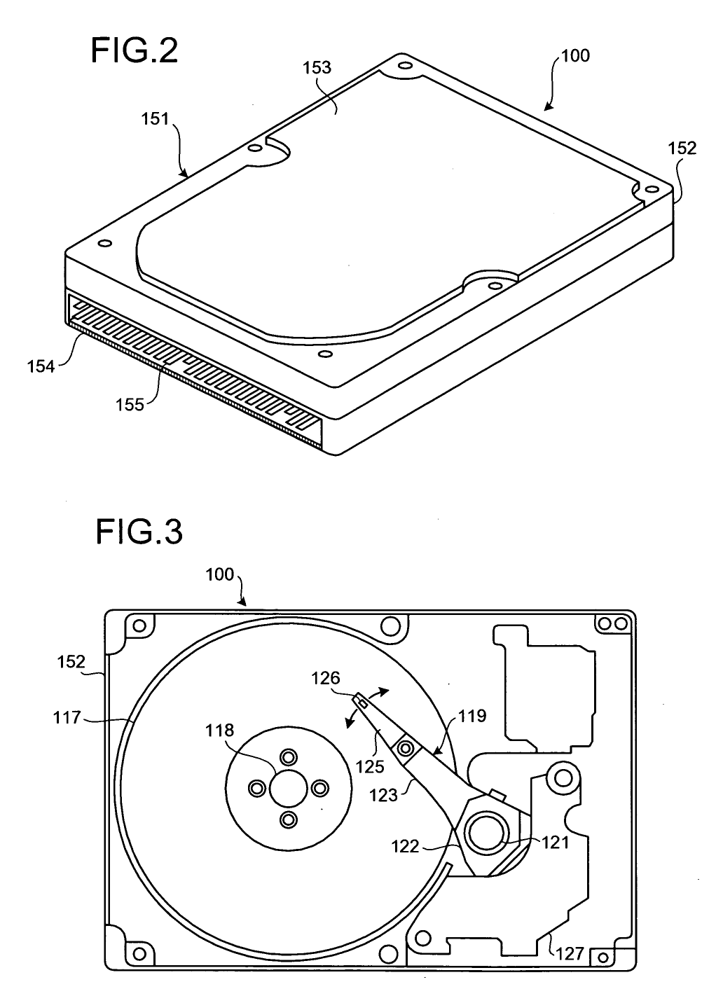

FIG. 2 is a schematic external view of a magnetic disk device according to the embodiment. The magnetic disk device 100 has a box-type housing 151. The housing 151 includes a box-type housing body 152 that is a plane rectangular solid and has a magnetic storage medium containing space, for example. The housing body 152 is molded of metal such as aluminum. A cover 153 is mounted on the housing body 152. The cover 153 is used to seal the magnetic disk medium containing space of the housing body 152. The cover 153 is manufactured of a metal sheet, for example, through press working. The metal sheet can be constituted of vibration-absorptive laminated materials, for example.

A printed circuit board 154 is provided on the outside of the housing body 152. On the printed circuit board 154 are provided not only a large integrated circuit (LSI) chip such as central processing unit (CPU) (or micro controller unit (MCU)), micro processing unit (MPU), a hard disk controller (not shown) but also a connector 155. Control of the magnetic disk device 100 is realized by the operations of the CPU and the hard disk controller. A control signal cable and a power source cable (both not shown) from a main board of a computer system on which the magnetic disk device 100 is mounted are connected to the connector 155. The CPU and the hard disk controller operate through power supplied from the power source cable.

FIG. 3 is a schematic of an internal configuration of the magnetic disk device 100. When the cover 153 is removed from the magnetic disk device 100, it is understood, as shown in FIG. 2, that at least a magnetic disk 117 is accommodated as a storage medium in the magnetic storage medium containing space. The magnetic disk 117 is supported about a rotating shaft of a spindle motor 118. The magnetic disk 117 can be rotated at high speed such as 7200 revolutions per minute or 10000 revolutions per minute by means of the spindle motor 118, for example.

A magnetic head actuator 119 is accommodated in the magnetic storage medium containing space. The magnetic head actuator 119 has an actuator block 122 rotatably supported about a vertically extended spindle 121. A rigid actuator arm 123 is horizontally mounted to the actuator block 122 in an extended manner from the spindle 121. The actuator block 122 is molded of aluminum, for example.

A magnetic head suspension 125 is attached on top of the actuator arm 123. The magnetic head suspension 125 extends ahead from the top of the actuator arm. A floating magnetic head slider is supported on top of the magnetic head suspension 125. Thus, the floating magnetic head slider is coupled to the actuator block 122. The floating magnetic head slider faces the surface of the magnetic disk 117.

A magnetic head 126, that is, an electromagnetic conversion element (not shown) is mounted on the floating magnetic head slider. The electromagnetic conversion element is constituted of a read element that is a giant magnetoresistance (GMR) effect element or a tunneling magnetoresistance (TMR) effect element that reads out information from the magnetic disk 117 by use of change of resistance in a spin valve film or a tunnel junction film, for example, and a writing element that is a thin film magnetic head that writes information on the magnetic head 117 by use of a magnetic field produced at a thin film coil pattern.

A power source 127 such as a voice coil motor (VCM) is connected to the actuator block 122. The actuator block 122 can be rotated about the spindle 121 through the operation of the power source 127. The rotation of the actuator block 122 makes the actuator arm 123 and the magnetic head suspension 125 swing. When the actuator arm 123 swings about the spindle 121 while the floating magnetic head slider floats, the floating magnetic head slider can move across the surface of the magnetic disk 117 in the radial direction. When a plurality of the magnetic disks 117 are incorporated in the housing body 152, the two actuator arms 123, that is, the two magnetic head suspensions 125 are arranged between the adjacent magnetic disks 117.

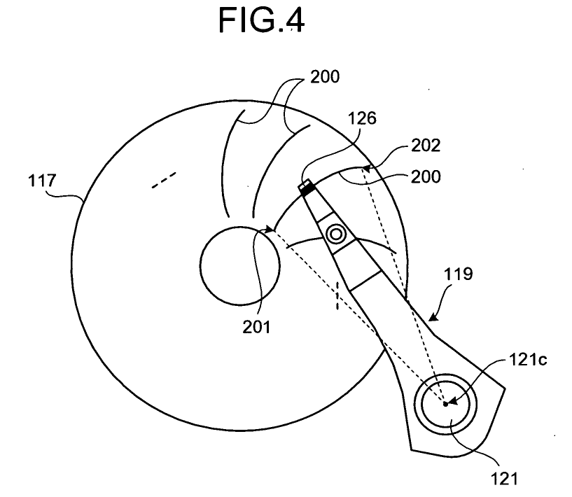

An explanation is given about servo information that is patterned on the surface of the magnetic disk 117 contained in the magnetic disk containing space inside the magnetic disk device 100 by referring to FIG. 4. Servo information represents how the magnetic head is positioned. As shown in FIG. 4, servo information 200 that extends from the center of the rotating magnetic disk in the radial direction like an arc is recorded on the magnetic disk 117 as a magnetic pattern.

The servo information 200 is arranged at regular intervals from the center of the magnetic disk 117 to the outer periphery substantially in the radial direction as an arc on the surface of the magnetic disk 117. Why the servo information 200 is arc-shaped is explained by the following reason. That is to say, the magnetic head actuator 119 on which the floating magnetic head slider with the magnetic head on its top is mounted makes a half-turn like a fan, serving a center spindle 121c of the spindle 121 as a rotating spindle. This is for the purpose of keeping the distance from the center spindle 121c to the magnetic head constant when the magnetic head follows the servo information between an end point 201 and an end point 202.

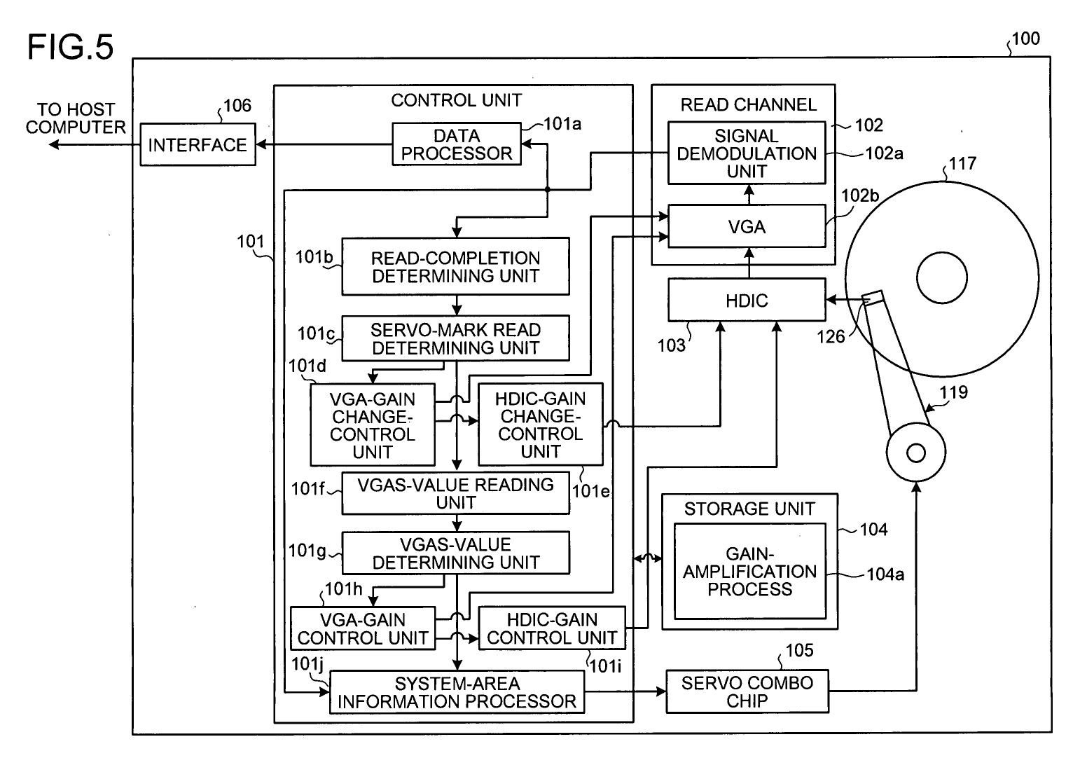

FIG. 5 is a functional block diagram of the magnetic disk device 100. The magnetic disk device 100 includes a control unit 101, a read channel 102, an HDIC 103, a storage unit 104, a servo combo chip (SVC) 105, an interface 106 that controls communication with a host computer (not shown), the magnetic disk 117, the magnetic head actuator 119, and the magnetic head 126. Other configuration and functions associated with the configuration are the same as in a typical magnetic disk device and the explanation is omitted.

The control unit 101 includes CPU (MCU or MPU) that performs various processing by using a control program and control data prescribing various procedures stored in the storage unit 104. The control unit particularly includes a data processor 101a, a read-completion determining unit 101b, a servo-mark read determining unit 101c, a VGA-gain change-control unit 101d, an HDIC-gain change-control unit 101e, a VGAS-value reading unit 101f, a VGAS-value determining unit 101g, a VGA-gain control unit 101h, an HDIC-gain control unit 101i, and a system-area information processor 101j that are closely associated with the embodiment.

The data processor 101a records data provided from the host computer on the magnetic disk 117 and provides data of the magnetic disk 117 (data read and reproduced from the magnetic disk 117) from a demodulating unit 102a of the read channel 102 in accordance with a request from the host computer to output the data through the interface 106 to the host computer.

The read-completion determining unit 101b determines whether data received from the demodulating unit 102a is provided after information of a system area has been already read. When the determination result is in the affirmative, the data received from the demodulating unit 102a is further delivered to the servo-mark read determining unit 101c. When the determination result is in the negative, the data received from the demodulating unit 102a is discarded.

The servo-mark read determining unit 101c determines whether the data received from the read-completion determining unit 101b is provided after a servo mark has been already read. When the determination result is in the negative, the servo-mark read determining unit 101c provides an instruction of controlling a gain in VGA with respect to the VGA-gain change-control unit 101d. When the determination result is in the affirmative, the data received from the read-completion determining unit 101b is further delivered to the VGAS-value reading unit 101f.

The VGA-gain change-control unit 101d instructs a VGA 102b to increase the gain amplification level in the VGA 102b by one step according to an instruction from the servo-mark read determining unit 101c. The VGA-gain change-control unit 101d instructs the HDIC-gain change-control unit 101e to increase gain amplification level in the HDIC 103 by one step.

The HDIC-gain change-control unit 101e instructs the HDIC 103 to increase the gain amplification level in the HDIC 103 by one step according to an instruction from the VGA-gain change-control unit 101d.

The VGAS-value reading unit 101f reads a VGAS value from the data received from the read-completion determining unit 101b. The read VGAS value is delivered to the VGAS-value determining unit 101g.

The VGAS-value determining unit 101g determines whether the VGAS value received from the VGAS-value reading unit 101f is within a range of a predetermined threshold value. When the determination result is in the negative, the VGAS-value determining unit 101g instructs the VGA-gain control unit 101h to perform VGA gain control. When the determination result is in the affirmative, the VGAS-value determining unit 101g instructs the system-area information processor 101j to obtain system area information from the signal received from the demodulating unit 102a and send the information to the SVC 105.

The VGA-gain control unit 101h instructs the VGA 102b to increase or decrease the gain amplification level in the VGA 102b by one step according to an instruction from the VGAS-value determining unit 101g. The instruction is based on the determination result of the VGAS-value determining unit 101g. That is, when the VGAS value equal to or more than a certain value is less than the lower limit of a predetermined threshold value range, the gain amplification level is increased by one step. When the VGAS value equal to or more than a certain value is more than the upper limit of a predetermined threshold value range, the gain amplification level is decreased by one step. The VGA-gain control unit 101h instructs the HDIC-gain control unit 101i to increase or decrease the gain amplification level in the HDIC 103 when not having instructed the VGA 102b to increase or decrease the gain amplification level in the VGA 102b.

The HDIC-gain control unit 101i instructs the HDIC 103 to increase or decrease the gain amplification level in the HDIC 103 by one step according to an instruction from the VGA-gain control unit 101h. The instruction is based on the determination result in the VGAS-value determining unit 101g. That is, when the VGAS value equal to or more than a certain value is less than the upper limit of a predetermined threshold value range, the gain amplification level is increased by one step. When the VGAS value equal to or more than a certain value is more than the upper limit of a predetermined threshold value range, the gain amplification level is decreased by one step.

The read channel 102 has the demodulating unit 102a and the VGA 102b. The demodulating unit 102a demodulates a reproduced signal that is the read signal gain-controlled at the VGA 102b to provide data (user data, servo information, and system area information) and delivers the provided data to the data processor 101a, the read-completion determining unit 101b, or the system-area information processor 101j.

The VGA 102b further amplifies the gain of the read signal received from the HDIC 103. The gain is amplified one-fold in an initial state, and the amplification level is increased or decreased by one step based on the instruction of the VGA-gain change-control unit 101d or the VGA-gain control unit 101h.

The HDIC 103 is a preamplifier and amplifies the gain of the read signal from the magnetic head 126. The gain is amplified one-fold in an initial state, and the amplification level is increased or decreased by one step based on the instruction of the HDIC-gain change-control unit 101e or the HDIC-gain control unit 101i.

The storage unit 104 stores therein a control program or control data that specifies various processing procedures. As a specific example of the control data, there is a gain-amplification process 104a that specifies amplification process.

The magnetic disk 117 is a storage medium that is formed to coat a magnetic film on a disk-like board that is made of metal or glass. When data is recorded to the magnetic disk 117, a magnetic field is applied from the magnetic head to a recorded area on which data of the magnetic disk 117 is recorded to change the magnetic condition of the magnetic substance on its surface for data recording. When reading out data from the magnetic disk 117 and reproducing it, the magnetic head 126 is moved to the recorded area to be reproduced on the magnetic disk 117 and reads out the magnetic condition of the magnetic substance of the magnetic disk 117 for data reproduction.

The magnetic head 126 records and reproduces data on/from the magnetic disk 117. The magnetic head 126 reads out servo information to manage a track position from the magnetic disk 117 and outputs the information to the HDIC 103 together with reproduced data from the magnetic disk 117.

Servo information is recorded in the magnetic disk 117 with data. The servo information also includes information about a track position and the unit of track, and information to determine a position of a cylinder.

The magnetic head actuator 119 has a voice coil motor (VCM) and moves the magnetic head 126 like a fan through control electric power output from the SVC 105.

The SVC 105 outputs control electric power to the magnetic head actuator 119 according to the instruction from the control unit 101 to control the movement of the magnetic head 126. The SVC 105 applies control electric power to a spindle motor (not shown) to control the rotation of the magnetic disk 117.

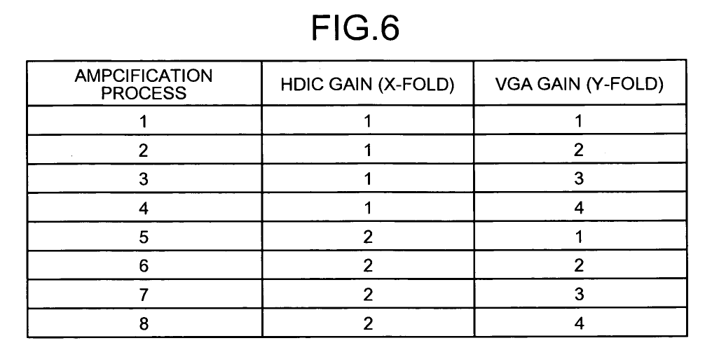

The gain-amplification process 104a is explained in detail. FIG. 6 is a table for explaining a process of amplifying a combination of a VGA gain and an HDIC gain, i.e., the gain-amplification process 104a. As shown in FIG. 6, the gain amplification of (1, 1), (2, 1), (3, 1), (4, 1), (1, 2), (2, 2), (3, 2), (4, 2) is performed in this order step by step as a combination (X, Y); X indicates that an HDIC gain is amplified X-fold and Y indicates that a VGA gain is amplified Y-fold. Thus, higher priority is first given to amplification of the gain in HDIC and is followed by amplification of the gain in VGA. As a result, it is possible to prevent noise in amplification that occurs in the HDIC 103 from further being amplified in the VGA 102b and to extremely suppress noise due to gain amplification.

The combination of a VGA gain and an HDIC gain is described above by way of example and without limitation. Servo information is output in VGAS that can be demodulated and that is output from the VGA 102b. When not reaching demodulation optimal output, the VGAS output is controlled to approach demodulation optimal output without limit. It is possible to more rapidly and efficiently search for a servo mark and to demodulate servo information by designing to mate a maximum value (that is referred as a pull-in width) of the difference between demodulation optimal output and the VGAS output with a changing width resulting from a change of one stage in the gain-amplification process 104a.

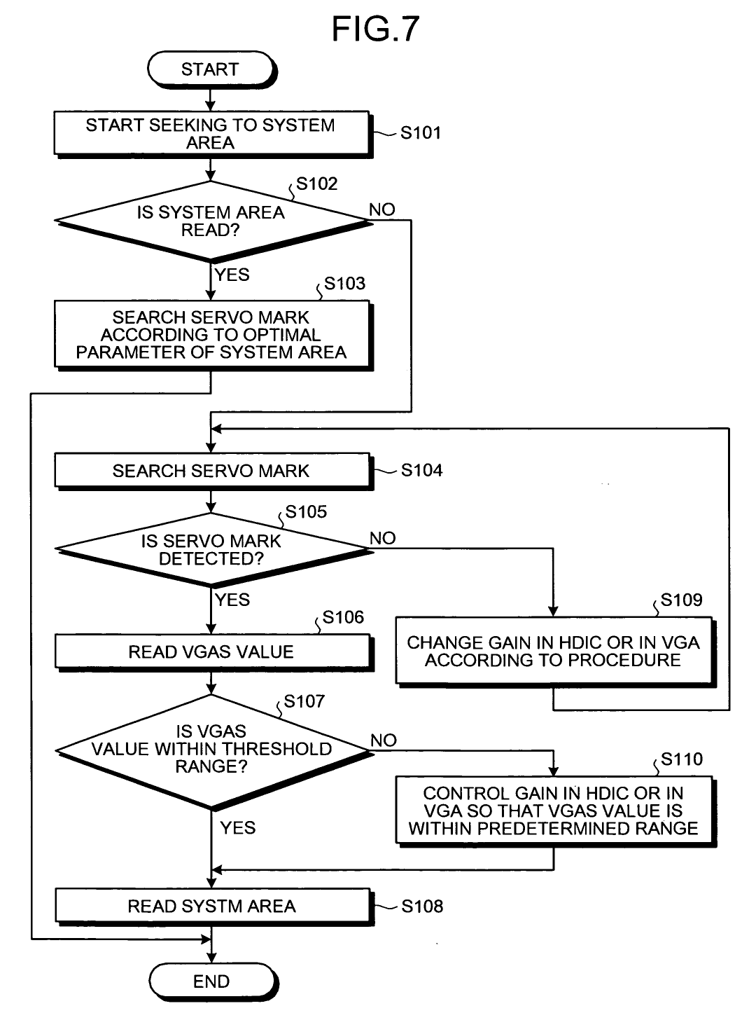

FIG. 7 is a flowchart of a gain control process while a system area is being read. As shown in FIG. 7, upon activation of the device (after power-on), seek operation is performed in a system area (at step S101). Next, whether the system area is read is determined (at step S102). When it is determined that the system area is read (Yes at step S102), the processing moves to step S103. When it is not determined that the system area is read (No at step S102), the processing moves to step S104.

A servo mark is searched based on an optimal parameter of a system area at step S103. End of this processing means end of gain control processing when reading out a system area.

A servo mark is searched in turn at step S104. It is determined whether the servo mark is searched (at step S105). When it is determined that the servo mark is detected (at step S105, in the affirmative), the processing moves to step S106. When it is not determined that the servo mark is detected (at step S105, in the negative), the processing moves to step S109.

At step S106, a VGAS value is read, and it is determined whether the VGAS value is in a range of a predetermined threshold value (at step S107). When it is determined that the VGAS value is within a range of the predetermined threshold value (at step S107, in the affirmative), the processing moves to step S108. When it is not determined that the VGAS value is within the range of the predetermined threshold value (at step S107, in the negative), the processing moves to step S110. At step S109, a gain in HDIC or in VGA is altered according to the execution procedure shown in FIG. 6, for example.

At step S108, the processing of reading out a system area is performed. At step S110, the gain in HDIC or in VGA is controlled so that the VGAS value is within a predetermined range. More specifically, the gain in HDIC or in VGA is controlled so that about half of the maximum gain control width is added to the VGAS value before or after the gain control. This makes it possible to prevent a demodulation error of a read signal and to easily acquire the demodulation result.

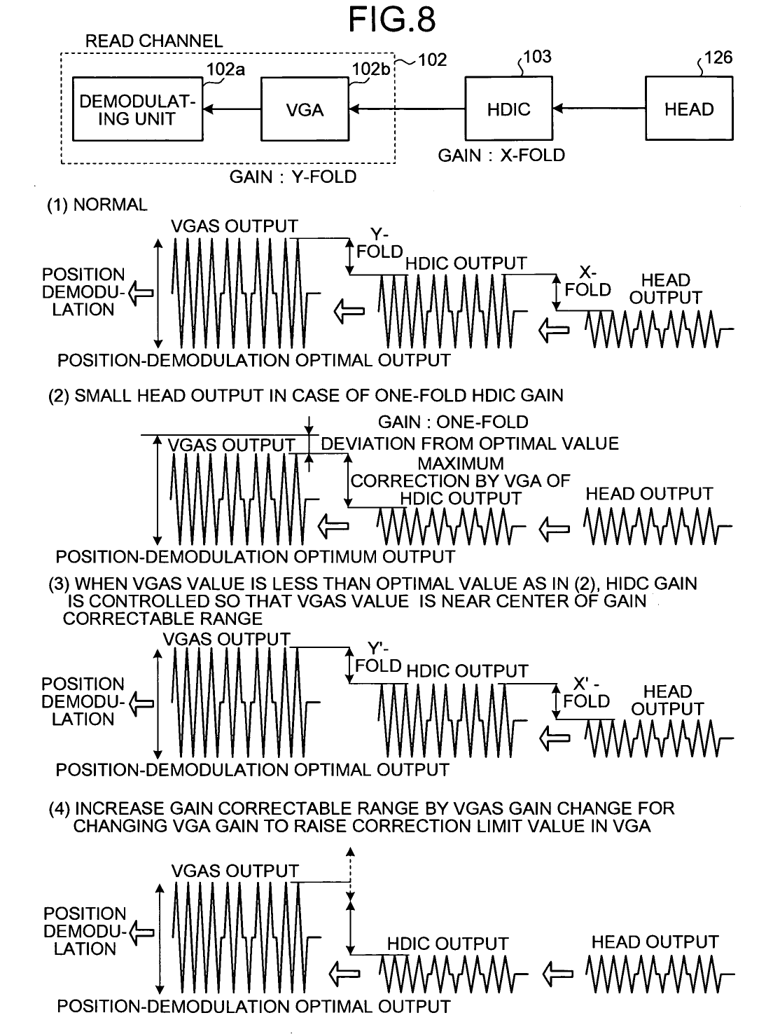

FIG. 8 is a schematic for explaining an outline of gain control. Referring to FIG. 8, the outline of the VGAS value provided by multiplying output of a read signal output from the magnetic head 126 by X in the HDIC 103 and multiplying it by Y in the VGA 102b is explained.

First, FIG. 8 (1) depicts that output of the magnetic head is correct so that VGAS output can be optimal for position demodulation based on servo information. When output of the magnetic head is multiplied by X in the HDIC 103 and the multiplied output is further multiplied by Y in the VGA 102b, VGAS output becomes optimal for position demodulation, enabling demodulation of position information from servo information.

FIG. 8 (2) depicts that output of the magnetic head is small in the case of a one-fold HDIC gain. When output of the magnetic head is originally too small, even if the output of the magnetic head is multiplied by Y only in the VGA 102b, VGAS output does not reach the output optimal for position demodulation so that position information can not be demodulated from servo information.

FIG. 8 (3) depicts that, when VGAS output does not reach the output optimal for position demodulation as shown in FIG. 8 (2), a gain in HDIC is multiplied by X′ and output in HDIC is multiplied by Y′ for VGAS to reach near the center of a range in which a gain can be controlled, thereby leading to VGAS output optimal for position demodulation and demodulation of position information from servo information.

As shown in FIG. 8 (4), without gain amplifying output of the magnetic head in the HDIC 103, a correction limit value in VGA is raised and a gain amplification rate in the VGA 102b is changed. Therefore, even the VGAS output provided by gain amplifying only in the VGA 102b becomes optimal for position demodulation and position information from servo information can be demodulated.

Thus, gain control (gain amplification) of HDIC output and VGA output is performed by appropriately selecting an amplification rate for each of them and VGAS optimal for position demodulation can be provided.

A computer programs can be executed by a CPU (or MCU, MPU) in the magnetic disk device 100 to realize various processes explained above. Various programs implementing the various processes are stored in the storage unit 104 in an example shown in FIG. 5. CPU reads out and executes the various programs to start various processes for implementing functions of the gain control device.

It should be noted that it is not necessary to store these programs in the storage unit 104 in advance and that the programs can be read from a portable physical recording medium or an external computer system connected through a network as needed and executed by CPU.

The processes are not necessarily implemented by computer program instructions or cords that are previously stored in the storage unit 104 and read and executed by CPU; however, they can be implemented by wired logic.

Gain control of output of the magnetic head in two stages that are in the HDIC 103 and in the VGA 102b is performed, but not limited to, before reading out a system area on startup of the device (after power-on) in the embodiment. Gain control can be performed during operation when an error of output occurs. In other words, in consideration of effects due to reduction in output that is caused by environmental changes or the like during the operation of the storage device, gain control can be performed as needed.

According to the present invention, advantageously, even a magnetic head that has a small output can be used in a storage device and yield associated with manufacture of a magnetic head can be improved. In particular, it is effective for a magnetic head that has a small output in the vertical magnetic recording system. In addition, a magnetic head for whatever output can be used in a storage device so that it is not necessary to have a step of selecting/discarding a magnetic head, as a result, leading to an improved production efficiency and controlled production cost in the storage device.

As set forth hereinabove, according to an embodiment of the present invention, signal gain is amplified by two stages of amplifiers. Upon activation of the storage device, the first gain control is performed based on output from a head of the storage device to position the head on a track. Therefore, the range of output from the head that can be subjected to gain control is increased, and even a conventional head with small output can be used in the storage device.

Moreover, with respect to a head with various outputs substantially different from one another, the head can be positioned on a track without causing a servo-mark detection error or a seek error before the activation of the storage device.

Furthermore, combinations of parameters are ordered for gain control of the two stages of amplifiers. Thus, efficient gain control can be performed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A gain control device that controls gain of a data read signal output from a head of a storage device upon activation of the storage device, the gain control device comprising:
a first gain control unit that controls gain of a first read signal to obtain a second read signal; and
a second gain control unit that controls gain of the second read signal to obtain a third read signal.

2. The gain control device according to claim 1, wherein the first gain control unit controls the gain of the first read signal before a system area of the storage device is read immediately after the activation of the storage device.

3. The gain control device according to claim 1, further comprising a storage unit that stores therein a plurality of combinations of parameters in a specific order to be used in gain control of the first gain control unit and the second gain control unit, wherein
the first gain control unit and the second gain control unit control the gain of the first read signal and the second read signal based on the order.

4. The gain control device according to claim 1, wherein the first gain control unit further controls the gain of the third read signal.

5. The gain control device according to claim 1, further comprising:
a determining unit that determines whether the gain of the third read signal is within a predetermined range; and
a gain re-control unit that further controls, when the gain of the third read signal exceeds the predetermined range, the gain of the third read signal so that the gain is within the predetermined range.

6. A storage device that controls gain of a data read signal output from a head thereof upon activation, the storage device comprising:
a first gain control unit that controls gain of a first read signal to obtain a second read signal; and
a second gain control unit that controls gain of the second read signal to obtain a third read signal.

7. The storage device according to claim 6, wherein the first gain control unit controls the gain of the first read signal before a system area thereof is read immediately after the activation.

8. The storage device according to claim 6, further comprising a storage unit that stores therein a plurality of combinations of parameters in a specific order to be used in gain control of the first gain control unit and the second gain control unit, wherein
the first gain control unit and the second gain control unit control the gain of the first read signal and the second read signal based on the order.

9. The storage device according to claim 6, wherein the first gain control unit further controls the gain of the third read signal.

10. The storage device according to claim 6, further comprising:
a determining unit that determines whether the gain of the third read signal is within a predetermined range; and
a gain re-control unit that further controls, when the gain of the third read signal exceeds the predetermined range, the gain of the third read signal so that the gain is within the predetermined range.

11. A gain control method for controlling gain of a data read signal output from a head of a storage device upon activation of the storage device, the gain control method comprising:
controlling gain of a first read signal to obtain a second read signal; and
controlling gain of the second read signal.
